(19) United States
(12) Patent Application Publication
(10) Pub. No.: US 2004/0245674 A1
(43) Pub. Date: Dec. 9, 2004

(54) Method for packaging small size memory cards

(76) Inventors: Chee Kiang Yew, Singapore (SG); Piau Fong, Penang (MY); Keng Siew Matthew Chua, Penang (MY)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 10/820,011

(22) Filed: Apr. 8, 2004

Related U.S. Application Data
(63) Continuation-in-part of application No. 10/412,731, filed on Apr. 11, 2003.

(51) Int. Cl. B29C 31/00

(52) U.S. Cl. 264/272.17; 425/110

(57) ABSTRACT

The present invention provides methods for packaging small size memory cards wherein the methods comprise molding over a populated printed circuit board, thereby an encapsulated memory card is obtained with desirable external dimensions and features. In one aspect of the invention, methods are provided for preventing mold bleed underneath of the contact pads of memory cards. In one embodiment, the mold bleeding is prevented by using slidable holding pins that exert pressure directly upon the contact pins during the molding process. In another embodiments, the mold bleeding is prevented by covering the contact pads with temporary substrate coverage during the molding process. In yet another embodiment, the mold bleeding is prevented by using pressing edges that exert pressure directly upon the area of contact pads during the molding process. In still another embodiment, the mold bleeding is prevented by using vacuum pressure to secure the populated PCB onto the bottom of a molding apparatus. In yet still another embodiment, the mold bleeding is prevented by mounting dummy components onto the area opposite to the contact pads in a populated PCB, thereby the dummy components exert direct pressure to the contact pads during the molding process.

### FIELD OF THE INVENTION

The present invention generally relates to the manufacture of small size memory cards, and more particularly to methods for the packaging of the small size memory cards.

### BACKGROUND OF THE INVENTION

Memory cards have been widely used in electronic devices such as digital cameras, personal digital assistants, musical instruments, voice recorders, facsimile machines, printers, scanners, word processors, game machines, PC cards, and the like. The general trend in devices using the memory card is to make the devices smaller, lighter, thinner, more reliable, and less expensive. Meeting this trend requires smaller memory cards.

Small size memory cards are very diversified including xD Picture card, Secure Digital™ (SD) card, SmartMedia™ (SM) card, Multimedia card (MMC), CompactFlash™ (CF) card and PC card. The small size memory cards are conventionally assembled as shown in FIG. 1 by first making a printed circuit board (PCB) with leads and die pads, mounting dies such as flash memory microchips onto the die pads of the PCB, bonding wires between the contact pads of the microchips and the leads of the PCB, and encapsulating the populated PCB with a two-piece plastic or metal housing that may be sealed by microwave or ultrasound.

The conventional assembly of small size memory cards has certain drawbacks. For example, the making and closing of the two-piece housings increase the steps of encapsulation. In addition, the housing must have minimum internal gaps or spaces so that the populated PCB can be fitted therein and damages to the chips will be avoided when the housing is closed. The spaces cause the assembled card to flex under stress resulting in deterioration in quality and the product life time including delamination, crack, and separation. Furthermore, the tapered supporting padding 22 for the leads decreases the internal spaces of the housing available for mounting chips. Finally, the minimal thickness of the housing walls limits the internal spaces 24 of the housing. In short, use of a separately formed cover not only adds undesirable thickness to the card but requires additional process steps and is subject to deleterious detachment of the cover from the substrate. In addition, any variation in mounted component height and overlying glob top material will result in card thickness variation.

There have been methods developed to address the problems in the conventional assembly. For example, U.S. Pat. No. 6,483,038 discloses a memory card comprising a card base and a semiconductor package, wherein the card base comprises a first surface having a cavity formed thereon and a second surface, and the semiconductor package comprises a substrate, memory chips, and molding resin layer, and is mounted on the cavity so that external contact pads are exposed.

However, the molding material bleeds underneath the contact pads of a memory card. The bled molding materials affect the quality of the memory cards.

Therefore, there is an imperative need to have a small size memory card that has clean contacts pads with simple manufacturing process at a low cost. This invention satisfies this need by disclosing methods of encapsulating small size memory cards. Other advantages of this invention will be apparent with reference to the detailed description.

### SUMMARY OF THE INVENTION

The present invention provides methods for packaging small size memory cards wherein the methods comprise molding over a populated printed circuit board, thereby an encapsulated memory card is obtained with desirable external dimensions and features.

In one aspect of the invention, the method comprises providing a populated PCB and molding over both sides of the populated PCB to encapsulate the board. Preferably, the populated PCB is held in place in a cavity of at least one mould piece prior to the molding. In one preferred embodiment, the populated PCB comprises at least one tie bar extending therefrom, wherein holding the populated PCB in place in the cavity of the at least one mould piece comprises securing the at least one tie bar in place in the cavity of the at least one mould piece.

Preferably still, the tie bar extends to a peripheral frame which integrally and substantially surrounds the populated PCB, thereby holding the populated PCB in place in the cavity of the one mould piece by securing a portion of the peripheral frame. The peripheral frame may preferably be provided with a plurality of tie bars, which are optimally distributed around said peripheral frame to prevent flexure of said populated PCB as it is held within the mold piece.

In another aspect of the invention, one edge of the populated PCB may be provided for holding said board in place for the encapsulating process in the mold piece. Preferably, one or more perforation through the PCB may be provided to allow for the molding compound to flow therethrough during encapsulation to provide for integral connection between said molding compound on the two sides of the PCB.

The complete encapsulated memory card may be separated from the holding means by conventional methods including any one of scribing-and-breaking, sawing, punching and cutting.

The encapsulation process may include any one or combination of transfer molding and injection molding processes. Preferably, a two-step molding may include any combination of molding over one side prior to the other side of the populated PCB, or molding part of one side of the PCB prior to the rest. In certain embodiments, the molding process may simultaneously mold over both sides of the populated PCB.

In certain embodiments, a populated PCB may include chip-on-board (COB) or multiple chip modules (MCM) components mounted thereon, including direct flip chip on board (FCOB), wire-bonded chips and other forms of interconnect between the chip and the PCB. Preferably, the FCOB is a flash memory chip module, including any one of a solder-bumped flip chip, wire-bonded chip and other forms of interconnect between the chip and the PCB, packaged on a land-grid array (LGA) chip scale package (CSP).

In yet another aspect of the invention, the standard external dimensions and features of the memory card may include any one or combination of openings for contact pads or pins extending from the PCB and write-protect means. Preferably, the write-protect means is completed with a separate member inserted into a groove provided with the encapsulated card and slidable along said groove.

In still another aspect of the invention, methods are provided for preventing mold bleeding underneath of the contact pads of memory cards. In one embodiment, the mold bleeding is prevented by using slidable holding pins that exert pressure directly upon the contact pins during the molding process. In another embodiments, the mold bleeding is prevented by covering the contact pads with temporary substrate coverage during the molding process. In yet another embodiment, the mold bleeding is prevented by using pressing edges that exert pressure directly upon the area of contact pads during the molding process. In still another embodiment, the mold bleeding is prevented by using vacuum pressure to secure the populated PCB onto the bottom of a molding apparatus. In yet still another embodiment, the mold bleeding is prevented by mounting dummy components onto the area opposite to the contact pads in a populated PCB, thereby the dummy components exert direct pressure to the contact pads during the molding process.

The method of the invention may be used to manufacture a small size memory card including xD Picture card, Memory Stick™, Secure Digital™ (SD) card, SmartMedia™ (SM) card, Multimedia card (MMC), CompactFlash™ (CF) card and PC card.

One object of the present invention is to provide methods of encapsulating a small size memory card that overcome the shortcomings of the conventional assembly by avoiding the steps of (i) moulding separately the two pieces of housing, (ii) assembling the 2-piece housing into the complete memory card, and (iii) sealing the said housing pieces together by ultrasound or microwave.

Another object of the present invention is to allow the memory card to be packaged in a housing without the need for tolerances to fit the corresponding component profile of the populated PCB therewithin. The resultant molded memory card according to the present invention further provides for a sturdy and integral package, which prevents the assembled card from flexing under stress.

Yet another object of the present invention is to eliminate the tapered portion so as to enable the area behind the contact pads of the PCB to be populated with components without foregoing the reinforcing or padding aspect

Still another object of the present invention is to maximize the internal space. The molding method of the invention is not limited by minimum thickness of individual housing pieces.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 (Prior art) shows a schematic configuration of a conventional memory card in cross-sectional view.

FIG. 2 shows a schematically cross-sectional view of an encapsulated SD card within a molding apparatus.

FIG. 3 shows one embodiment of the tie-bar configuration of the populated PCB in plan view.

FIGS. 4A, 4B and 4C show other embodiments of the tie-bar configurations of the populated PCB in plan view.

FIG. 5 shows one embodiment of perforation of the PCB in cross-sectional view.

FIGS. 6A, 6B, 6C, and 6D show alternative embodiments of the slidable write-protection switch.

FIG. 7 illustrates prevention of mold bleed during molding process by using holding pins. FIG. 7A is a top view of an encapsulated card showing the holes corresponding to the holding pins. FIG. 7B is a back view of the encapsulated card showing the contact pads without mold bleed. FIG. 7C is a cross-section view of the contact pads. FIG. 7D shows a schematically cross-section view of the encapsulated card within a molding apparatus, wherein the molding apparatus has special slots designed for the holding pins.

FIG. 8 illustrates prevention of mold bleed during molding process by using support insert exerting pressure directly upon the opposite side of the contact pads.

FIG. 9 illustrates prevention of mold bleed during molding process by using temporary substrate coverage. FIG. 9A shows the presence of temporary substrate coverage at the contact pads to ensure zero mold bleed. FIG. 9B shows clean contact pads after peeling off the temporary substrate coverage.

FIG. 10 illustrates prevention of molding bleed during molding process by using vacuum exerting pressure upon the substrate.

FIG. 11 is a schematically cross-section view of an encapsulated memory card containing dummy components that exert direct pressure upon the contact pads.

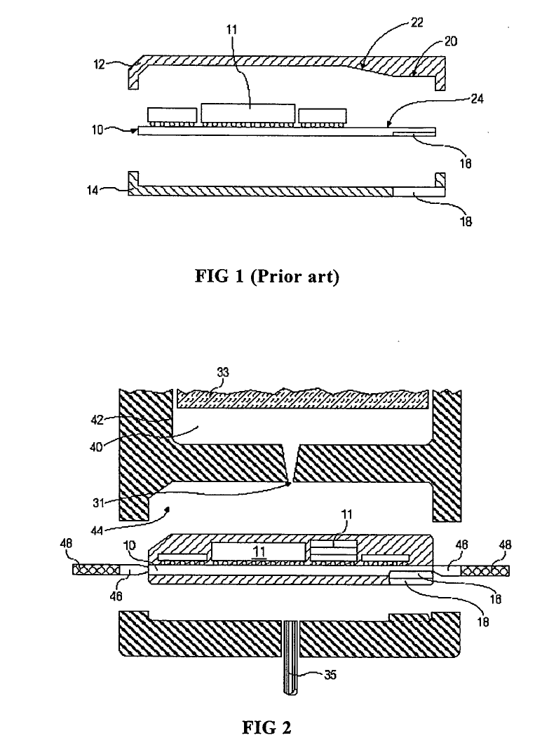

### DETAILED DESCRIPTION OF THE INVENTION

The present invention may be understood more readily by reference to the following detailed description of certain embodiments of the invention. While the following description discloses specific embodiments of packaging of Secure Digital (SD) cards, it is to be understood that the methods are applicable to other types of small size memory cards including SmartMedia™ (SM) card, Multimedia card (MMC), CompactFlash™ (CF) card, PC card, Memory Stick™, xD Picture card and the like. The methods are also applicable to small size memory cards which formats and specifications may be introduced in the future.

Throughout this application, where publications are referenced, the disclosures of these publications are hereby incorporated by reference, in their entireties, into this application in order to more fully describe the state of art to which this invention pertains.

FIG. 2 shows a schematically cross-sectional view of an encapsulated SD card within a molding apparatus. The general molding process enabling the encapsulation of the populated PCB 10 comprises providing the populated PCB in a mold, which has been tooled to form the standard external dimensions and features of designated memory cards, and then pushing an amount of molding polymer 40 at high pressure into the mold cavity, thereby the molding material flows over both sides of the populated PCB 10 and encapsulates the populated PCB 10.

Preferably, the “printed circuit board” (PCB) covers circuits board of a substantially rigid type suitable for withstanding process handling and encapsulation of the present invention, including glass and ceramic laminates such as Bismaleimide/Triazine (BT), FR4 and FR5 (glass cloth/epoxy), and other suitable materials.

The substrate of the package is preferably made of an insulating material such as BT resin (Bismaleimide Triazine Resin) or glass-epoxy resin. The molding resin layer is preferably made of epoxy molding compounds. The circuit wirings and the external contact pads are preferably copper patterns plated with nickel or gold. However, any suitably conductive material can be used in place.

For electrical connection between the memory chip and the substrate, instead of a wire bonding method using the metal wires, a TAB (Tape Automated Bonding) method using the tape wiring board on which copper wirings are formed on the insulating tape or a method using an ACF (An-Isotropic Conductive Film) on which conductive particles are dispersed in the resin may be alternatively used.

A plurality of external contact pads exposed on the surface of the memory card are connected to the digital products to provide electrical connection between the memory chip and the digital products. The external contact pads are disposed on only one end of the memory card. The shape and position of the contact pads and circuit wiring depend on the type or application of the memory card or other functional needs.

Various molding techniques such as reaction injection molding, compression molding and transfer molding may be adapted for the present invention. In certain embodiments, the transfer molding is particularly favored because the molding polymer 40 acquires uniform temperature and properties in the transfer pot 42 prior to being transferred into the mold cavity. The molten polymer 40 may further be heated by shearing through the sprue 31. Thus the reduced viscosity enables the plastic to fill intricate details of the mould cavity upon the high pressure exerted by the punch 33. The low viscosity also reduces the damage to delicate wires and components of the PCB. Upon the curing of the polymer, ejector 35 or knockout pin may be provided to eject the completed memory card from the lower mould piece 37.

The encapsulant must posses material properties that will enable it to protect the chip from adverse environments, contaminants, package handling, storage and second level assembly. Mechanical strength, adhesion to silicon and substrate, CTE compatible with silicon and substrate, temperature and moisture resistance, electrical insulation, chemical resistance, and flow characteristics are some of the traits to consider when selecting an encapsulant for a given application.

It is to be appreciated that various molding processes may be used for the encapsulation. For example, a two-step molding may include any combination of molding over one side prior to the other side of the populated PCB 10, or molding part of one side of the PCB prior to the rest. In certain embodiments, the molding process may simultaneously mold over both sides of the populated PCB 10.

In certain embodiments, the resin-molded layer forms half of a body of the memory card. The substrate forms the remaining half of the card body. Therefore, the substrate and the resin-molded layer respectively form a first surface and an opposing second surface of the memory card. Side surfaces of the substrate and the resin-molded layer are coplanar.

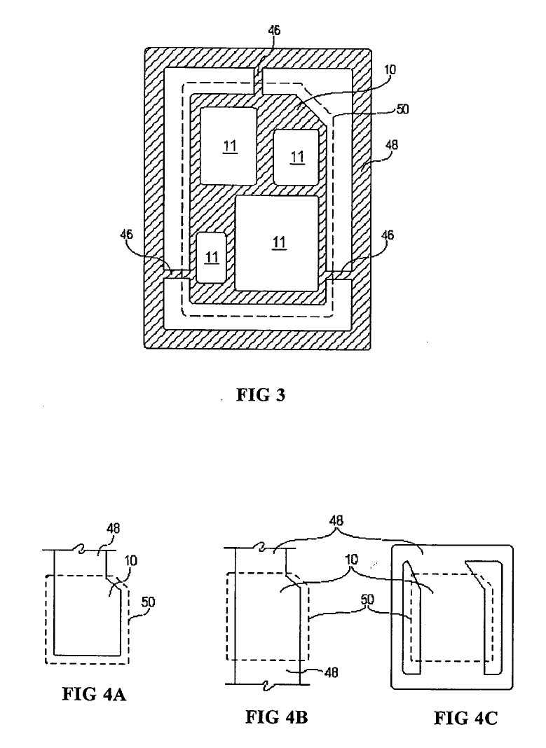

The PCB may be fabricated with one or more tie bars 46 linking to a peripheral frame 48 as shown in plan view of FIG. 3. The peripheral frame enables the populated PCB 10 to be held in place in the molding cavity 44 during the encapsulation process for producing the memory card whose outer dimension is shown in the broken line 50. Upon the polymer being cured, the tie bars 46 may be broken so that the complete memory card is separated from the peripheral frame 48.

Apart from providing tie bars 46 and distributing them accordingly around the peripheral frame 48, it is also possible to provide the peripheral frame 48 integral with the populated PCB (10) along any one or more edges of the PCB as shown in FIGS. 4A, 4B, and 4C. To ease the detachment of the completely encapsulated memory card from the edge integral with the peripheral frame 48, various conventional means such as scribe-and-break, sawing, cutting and punching may be employed.

After the PCB with multi-substrates is prepared, the populated PCB 10 can be made by attaching semiconductor chips to the contact pads-opposite surface of each unit substrate and then electrically connecting to the circuit wiring on the associated unit substrate. An adhesive material such as epoxy can attach the chips to the unit substrates, and fine bonding wires such as gold can make the electrical connections between the chips and the wiring on the unit substrates. In certain embodiment, a single chip is attached to each unit substrate. In alternate embodiments, two or more chips are attached to each unit substrate. Additionally, some chips can be stacked on already attached chips.

The encapsulation process starts with the provision of the populated PCB 10 in the molding cavity 44 of a mold. The mold includes a lower mold and an upper mold. To form a resin-molded layer, the populated PCB 10 is set in the mold. The populated PCB 10 can be disposed into the lower or upper mold. When the mold is closed, the resin-molded layer is formed over the populated PCB 10.

It may be anticipated that an SD card encapsulated with an exposed edge, which may be seen on the edge of the finished memory card, may not be as sturdy as the one whose edges are well encapsulated and may be prone to delamination when flexed or undergoing warpage stress. One way to attenuate this problem is to provide perforation 52 on the PCB proximate to the edge so that the encapsulating compound 54 may flow through and form an integral joint between the two sides of the PCB as shown in cross-sectional view in FIG. 5.

The populated PCB may include various components on board such as chip-on-board (COB) and multiple chip modules (MCM). The chip-on-board component (COB) may be mounted onto the board as direct flip chip on board (FCOB) which may include flash memory module. The flash memory chip module may be a solder-bumped flip chip, or wire-bonded chip, or any combination of both, packaged on a land-grid array (LGA) chip scale package (CSP). Alternatively, the flip chip on board, or wire-bonded chip(s), may be mounted on a low-profile ball grid array (BGA).

It will be appreciated that the mold piece may be tooled to conform the standard external dimensions and features of the memory card including openings for contact pads or pins extending from the PCB and write-protect means.

In respect of the write-protect means, the conventional write-protect switch is provided as a separate switch piece slidable along a groove between the “write-enable” position and the “write-protect” position. The switch piece may be easily inserted in place in the groove when the 2-piece housing is assembled. For a memory card encapsulated according to the present invention, this poses a problem.

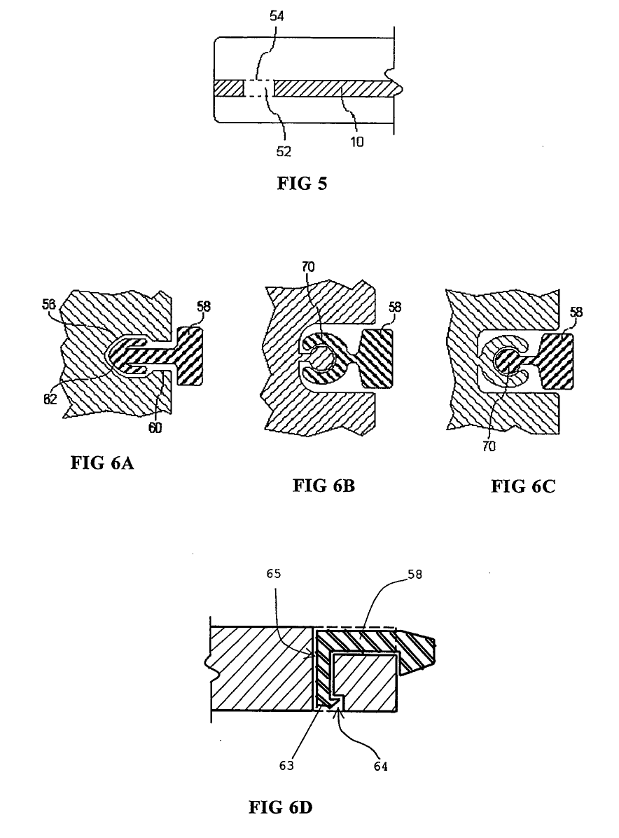

As shown in FIGS. 6A, 6B and 6C, it is proposed that the groove 56 be provided in the same configuration as in a 2-piece mould, and the slidable switch 58 be provided as a separate piece to be inserted and retained in the groove 56. In FIG. 6A, the groove 56 may be provided with a constricted neck portion 60 and the switch 58 provided with a flexible barbed end 62 so that the end may be inserted into the groove 56 as the barbs are flexibly contracted to pass through the neck portion 58. Once the barbs 62 reflex to their expanded states the switch is retained in the groove and slidably therealong. In FIGS. 6B and 6C, the slidable switch's mountings are shown as ball-and-socket connections.

In FIG. 6D, the slide switch 58 is retained in the molding by ways of a flexible barbed end 63 which may be inserted into the groove 64 whereupon the barbs flexibly contract to enable the end 63 to pass through the opening 65. Once the barbs 66 reflex to their expanded state the switch 58 is retained in the groove and slidably therealong.

It will be appreciated that, apart from the write-protect switch, other external features of the particular type of memory card may be similarly improvised for in the present one-piece encapsulating housing.

As discussed above, the contact pads connect the memory cards with digital products. In order to maintain good connections, the contact pads must be clean without contamination. During encapsulation, the molding materials including polymers contaminate the contact pads due to mold bleed. While the bled polymers over the contact pads may be cleaned in many ways, the cleansing adds extra step to the manufacturing process and increases the chances of damaging the encapsulated memory cards, resulting in higher manufacturing cost. Therefore, the present invention provides methods for prevention of mold bleed during the encapsulation of small size memory cards.

In one embodiment, the contacts pads of a populated PCB are tightly clamped so that the mold bleed over the contacts pads are prevented during encapsulation. The clamp means can be holding pins that can slidably move along special slots designed in the upper mold piece. After the populated PCB is secured in the lower mold piece, the holding pins touch the top side of individual contact pads exerting pressuring directly onto contact pads. The means and techniques for moving and locking the holding pins are well known in the art. For example, manual and automatic means are both contemplated in the present invention. While the size of the holding pins can vary, the size of the holding pins are preferably 75% or less in area corresponding to the contact pads. It is to be appreciated that the holding pins can be fixed to the upper mold piece. In addition, the encapsulation may be done by molding over the populated PCB or leaving the bottom side during the molding.

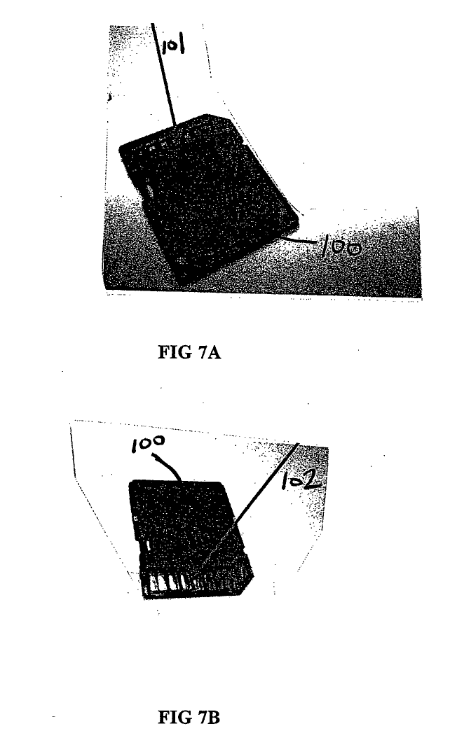

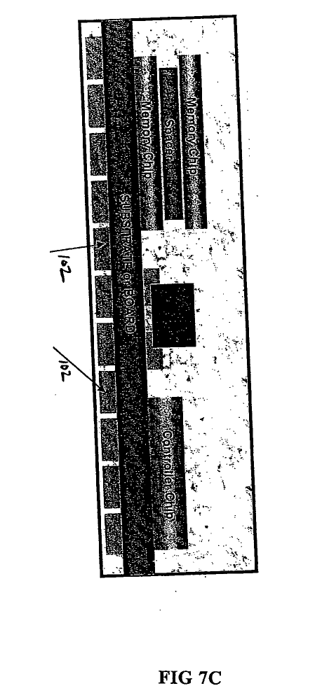

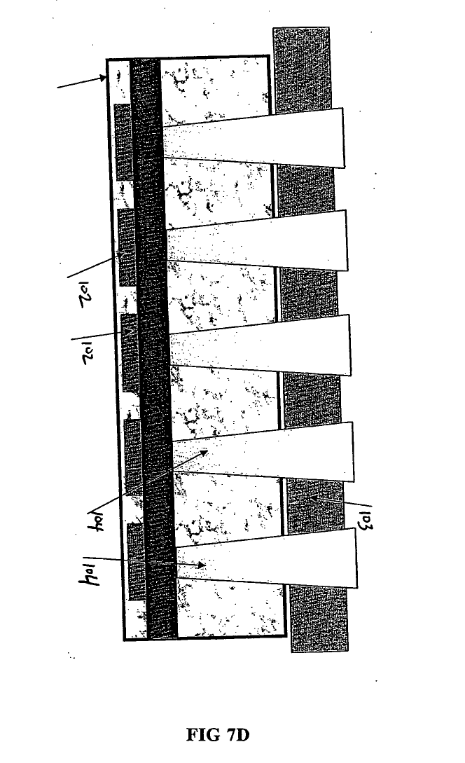

The holding pins can tightly clamp the contact pads so that the mold bleed onto the contact pads are substantially or totally eliminated. FIG. 7 shows prevention of mold bleed during molding process by using holdings pins, wherein the holding pins can slide along special slots designed in the upper mold piece. FIG. 7A is a top view of an encapsulated card 100 showing the holes 101 corresponding to the slidable holding pins. FIG. 7B is a back view of the encapsulated card 100 showing the contact pads 102 without mold bleed. FIG. 7C is a cross-section view of the contact pads 102 of the encapsulated card. FIG. 7D shows a schematically cross-section view of the encapsulated card within a molding apparatus 103, wherein the molding apparatus has special slots designed for the slidable holding pins 104.

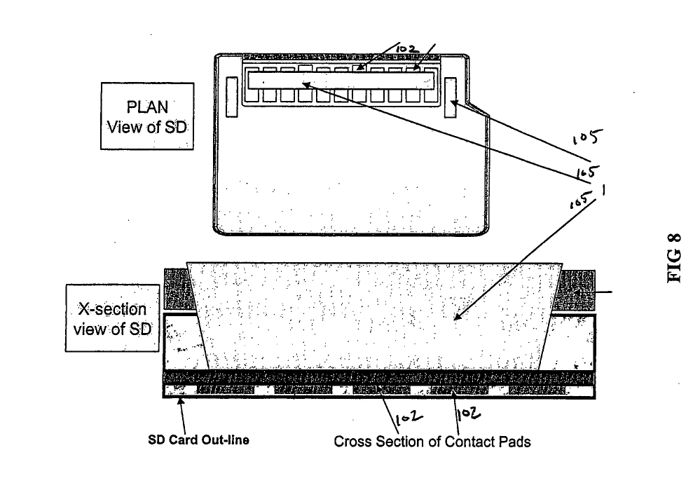

In another embodiment, the mold bleed onto the contact pads may be prevented by employing support insert from the top side of the populated PCB. As shown in FIG. 8, the support insert 105 has a knife edge holding/blocking pin. Like the holding pins discussed above, the support insert may be a fixture of the upper mold piece or slidable along with special slots designed in the upper mold piece. The support insert 105 disposed onto the opposite side of the contact pads, thereby exerting pressure directly upon the contact pads. The contact pads will be tightly clamped so that mold bleed onto the contact pads is substantially or completely eliminated.

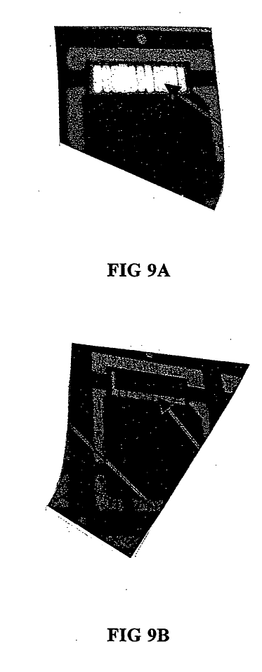

In yet another embodiment, the contact pads of a populated PCB are covered by a temporary substrate coverage to ensure zero mold bleed. The temporary substrate coverage is a layer that can be made of any known material. The temporary substrate coverage can be designed and attached to the contact pads in any known ways. For example, the temporary substrate coverage may be attached to the contact pads by selective lamination process and smart singulation/routing technique for easy detachment. A populated PCB with contact pads being covered with the temporary substrate coverage can be encapsulated in any known molding process. The un-laminated substrate coverage will be peeled off at the end of encapsulation, showing the fresh contact pads. FIG. 9 shows prevention of mold bleed during molding process by using temporary substrate coverage. FIG. 9A shows the presence of un-laminated temporary substrate coverage 106 at the contact pads to ensure zero mold bleed of the encapsulated card 100. FIG. 9B shows clean contact pads 102 after peeling off the temporary substrate coverage 106 upon the completion of encapsulation.

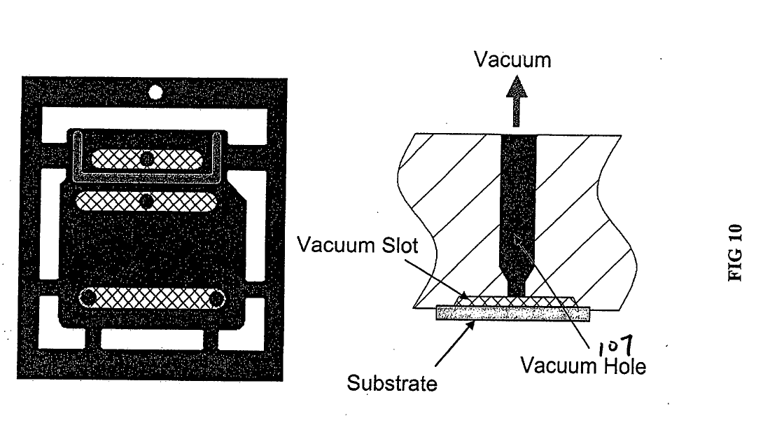

In a further embodiment, the contact pads can be clamped tightly onto the lower mold piece so that the mold bleed onto the contact pads will be prevented. As shown in FIG. 10, the populated PCB is sucked onto the lower mold piece by using vacuum exerting pressure upon the substrate. There are four vacuum holes 107 shown in FIG 10. It is to be appreciated that the location and vacuum strength may be varied in accordance with specific requirements. In certain processes, the temporary substrate coverage can be used in combination with the vacuum clamping.

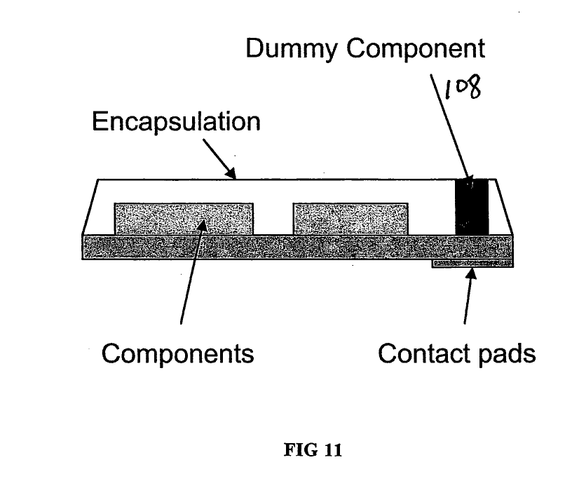

In a still embodiment, the contact pads of an encapsulated card may be prevented from mold bleed by employing at least one dummy component that will exert tight pressure upon the contact pads during molding. As shown in FIG. 11, a schematically cross-section view of an encapsulated memory card illustrates the at least dummy component 108 that exerts direct pressure upon the contact pads. The at least dummy component can be any item that satisfies the physical properties required for the molding. The dummy component may be disposed onto the PCB prior to the molding. The at least dummy component has such a height that when the mold is closed, the at least one dummy component will exert enough pressure over the contact pads to clamp the contact pads against the lower mold piece tightly, thereby the mold bleed onto the contact pads during molding is substantially or completely prevented. The specific number of dummy components to be employed will be determined by specific design. It is to be appreciated that the dummy components may be disposed upon any suitable location on the populated PCB.

It is to be appreciated that all the mechanisms for prevention of mold bleed may be combined if the combination is deemed suitable and desirable.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A method for packaging a small size memory card comprising a populated printed circuit board (PCB), said method comprising the following steps:
(a) providing the populated printed circuit board in a mold; and
(b) molding over the populated printed circuit board to encapsulate the populated printed circuit board, thereby providing the small size memory card with standard external dimensions and features.

2. The method of claim 1, wherein both the back side and top side of the populated PCB is encapsulated.

3. The method of claim 1, wherein the back side of the populated PCB is not encapsulated so that the back side forms one side of the encapsulated small size memory card.

4. The method of claim 1, wherein, in step (a), the populated PCB is held in place in a cavity of at least one mold piece of the mold.

5. The method of claim 4, wherein the populated PCB comprises at least one tie bar extending therefrom, and wherein the holding of the populated PCB in place in the cavity of the at least one mould piece comprises securing the at least one tie bar in place in the cavity of the at least one mould piece.

6. The method of claim 5, wherein the at least one tie bar extends to a peripheral frame which integrally and substantially surrounds the populated PCB, thereby holding the populated PCB in place in the cavity of the at least one mould piece by securing at least a portion of the peripheral frame.

7. The method of claim 6, wherein the peripheral frame is provided with a plurality of tie bars which are optimally distributed around said peripheral frame to prevent flexure of said populated PCB held within the at least one mould piece.

8. The method of claim 4, wherein at least one edge of the populated PCB is provided for holding said board in place for the encapsulating process in the at least one mould piece.

9. The method of claim 8, wherein one or more perforations through the PCB are provided to allow for the moulding compound to flow therethrough during encapsulation to provide for integral connection between said moulding compound on the two sides of the PCB.

10. The method of claim 1, further comprising the step of separating the complete encapsulated memory card from the holding means by any of methods including scribing-and-breaking, sawing, punching and cutting.

11. The method of claim 1, wherein the encapsulation process includes any one or combination of transfer moulding and injection moulding processes.

12. The method of claim 11, wherein the encapsulation is achieved by simultaneously molding over the populated PCB thereby forming the small size memory card at one step.

13. The method of claim 11, wherein the encapsulation is achieved by at two steps including any combination of molding over one side prior to the other side of the populated PCB or molding part of one side of the PCB prior to the rest.

14. The method of claim 1, wherein the populated PCB includes chip-on-board (COB) component mounted thereon.

15. The method of claim 1, wherein the populated PCB includes multiple chip modules (MCM) component mounted thereon.

16. The method of claim 14, wherein the chip-on-board component (COB) is mounted onto the board as any one of direct flip chip on board (FCOB), wire-bonded chips and other forms of interconnect between the chip and the PCB.

17. The method of claim 16, wherein the FCOB is a flash memory module.

18. The method of claim 17, wherein the flash memory chip module includes any one of a solder-bumped flip chip, wire-bonded chip and other forms of interconnect between the chip and the PCB, packaged on a land-grid array (LGA) chip scale package (CSP).

19. The method of claim 16, wherein the mounting of the COB on the board is a low-profile ball grid array (BGA).

20. The method of claim 1, wherein the standard external dimensions and features of said memory card include any one or combination of openings for contact pads or pins extending from the printed circuit board and write-protect means.

21. The method of claim 20, wherein the write-protect means is completed with a separate member inserted into a groove provided with the encapsulated card and slidable along said groove.

22. A small size memory card manufactured with a method according to claim 1.

23. A device installed with a memory card which has been manufactured with a method according to claim 1.

24. An apparatus, including at least a mold piece for carrying out the method according to claim 1.

25. A method for preventing contact pads of a populated print circuit board (PCB) from mold bleed during encapsulation for packaging a small size memory card, wherein the populated PCB has a back side with the contact pads and top side with at least one memory chip, and wherein the populated PCB is encapsulated by molding compounds in a mold having a lower mold piece and an upper mold piece, said method comprising:
disposing a plurality of holding pins in the mold, prior to the molding, so that the holding pins clamps the contact pads against the lower mold piece from the top side of the populated PCB when the mold is closed, thereby the mold bleed onto the contact pads during molding is substantially or completely prevented.

26. The method of claim 25, wherein the holding pins have 75% or less in area corresponding to the contact pads.

27. The method of claim 25, wherein the holding pins are slidable along special slots designed in the upper mold piece.

28. The method of claim 25, wherein the holding pins are fixtures onto the upper mold piece.

29. A method for preventing contact pads of a populated print circuit board (PCB) from mold bleed during encapsulation for packaging a small size memory card, wherein the populated PCB has a back side with the contact pads and top side with at least one memory chip, and wherein the populated PCB is encapsulated by molding compounds in a mold having a lower mold piece and an upper mold piece, said method comprising:
disposing a support insert in the mold, prior to the molding, so that the support insert clamps the contact pads against the lower mold piece from the top side of the populated PCB when the mold is closed, thereby the mold bleed onto the contact pads during molding is substantially or completely prevented;
wherein the support insert has a knife edge in contacting the top side of the populated PCB.

30. The method of claim 29, wherein the support insert is slidable along special slots designed in the upper mold piece.

31. The method of claim 29, wherein the support insert is a fixture onto the upper mold piece.

32. A method for preventing contact pads of a populated print circuit board (PCB) from mold bleed during encapsulation for packaging a small size memory card, wherein the populated PCB has a back side with the contact pads and top side with at least one memory chip, and wherein the populated PCB is encapsulated by molding compounds in a mold having a lower mold piece and an upper mold piece, said method comprising:
covering prior to molding the contact pads with a temporary substrate coverage that is un-laminated, thereby the mold bleed onto the contact pads during molding is substantially or completely prevented.

33. A method for preventing contact pads of a populated print circuit board (PCB) from mold bleed during encapsulation for packaging a small size memory card, wherein the populated PCB has a back side with the contact pads and top side with at least one memory chip, and wherein the populated PCB is encapsulated by molding compounds in a mold having a lower mold piece and an upper mold piece, said method comprising:
clamping prior to molding the populated PCB against the lower mold piece by vacuum from special channels designed in the lower mold piece, thereby the mold bleed onto the contact pads during molding is substantially or completely prevented.

34. A method for preventing contact pads of a populated print circuit board (PCB) from mold bleed during encapsulation for packaging a small size memory card, wherein the populated PCB has a back side with the contact pads and top side with at least one memory chip, and wherein the populated PCB is encapsulated by molding compounds in a mold having a lower mold piece and an upper mold piece, said method comprising:
disposing prior to molding at least one dummy components onto the top side of the populated PCB in the corresponding area of the contact pads, wherein the at least one dummy component has such a height that when the mold is closed, the at least one dummy component will exert enough pressure over the contact pads to clamp the contact pads against the lower mold piece tightly, thereby the mold bleed onto the contact pads during molding is substantially or completely prevented.

35. A small size memory card manufactured according to any one of claims 25, 29, and 32-34.
